(19) United States
(12) Patent Application Publication
(10) Pub. No.: US 2006/0051555 A1
(43) Pub. Date: Mar. 9, 2006

(54) Weighted placemat

(76) Inventor: Jolene F. Tshantz, North Canton, OH (US)

Correspondence Address: HAHN LOESER & PARKS, LLP, One GOJO Plaza, Suite 300, AKRON, OH, 44311-1076, US

(21) Appl. No.: 10/933,575

(22) Filed: Sep. 3, 2004

(51) Int. Cl. B32B 3/06

(52) U.S. Cl. 428/99

(57) ABSTRACT

The placemat 10 comprises an eating surface 12, a first attachment assembly 13 selectively attached to the eating surface 12 for selectively attaching the placemat to a surface during use, and a second attachment assembly 16 for selectively attaching the placemat to a seat assembly during use. In this particular embodiment, the first attachment assembly 13 comprises a weight 14. Alternative first attachment assemblies such as suction cups are contemplated and are considered to be within the scope of the invention. The term eating surface as it is used in this disclosure should be interpreted broadly and is simply the surface of the placemat 10 upon which food or items may be placed during use. The eating surface 12 is preferably made of, or covered by, a smooth, liquid-resistant material such as vinyl. Optionally, the eating surface 12 may be configured so as to be separately washable

### TECHNICAL FIELD

The present invention is directed to placemats and more specifically to a new and improved weighted placemat.

### BACKGROUND OF THE INVENTION

Parents and other caregivers strive to protect children from germs and infection. This is a constant battle, as young children love to place things into their mouths. Not only are foreign objects fair game, but so are a child's own hands. Often, a child's hands are infected with germs as a result of touching an infected surface. Thus, parents are continually cleaning and disinfecting every surface within arms reach of their little one.

Parents may not always be able to clean every surface their child touches. For example, a parent who takes their child out to eat may not be able to verify that all surfaces within arms reach of their child have been cleaned. Even if the area appears clean, it may still have a high concentration of germs.

Parents may solve this problem simply by carrying a traditional placemat wherever they may go. However, this solution falls short for many reasons, including the following. First, traditional placemats may be made of material, such as cloth, that is difficult to disinfect. Second, traditional placemats may not be practical to transport. Finally, it may be difficult to secure the placemat from being thrown off of a table.

### SUMMARY OF THE INVENTION

In view of the foregoing disadvantages in the prior art, a new and improved weighted placemat is presented. A preferred embodiment of the placemat comprises an eating surface, a first attachment assembly selectively attached to the eating surface for selectively attaching the placemat to a surface during use, and a second attachment assembly for selectively attaching the placemat to a seat assembly during use. An alternative preferred embodiment of the placemat comprises a first end, a second end, at least a first weight operably connected to the first end of the placemat, and an attachment assembly for selectively attaching the second end of the placemat to a seat assembly during use. Another alternative preferred embodiment of the placemat comprises a substantially rectangular member comprising a first end and a second end, at least a first weight operably connected to the first end of the member, and an attachment assembly attached to the second end of the member.

### BRIEF DESCRIPTION OF THE DRAWINGS

FIG. 1 is a top plan view of an embodiment of a weighted placemat according to the present invention.

FIG. 2 is a top plan view of an embodiment of a weighted placemat according to the present invention.

FIG. 3 is a bottom plan view of an embodiment of a weighted placemat according to the present invention.

FIG. 4 is a front elevational view of an embodiment of a weighted placemat according to the present invention.

FIG. 5 is a back elevational view of an embodiment of a weighted placemat according to the present invention.

FIG. 6 is a left elevational view of an embodiment of a weighted placemat according to the present invention.

FIG. 7 is a right elevational view of an embodiment of a weighted placemat according to the present invention.

FIG. 8 is a front elevational view of an embodiment of a weighted placemat according to the present invention.

FIG. 9 is a top plan view of an embodiment of a weighted placemat according to the present invention.

### DETAILED DESCRIPTION OF THE INVENTION

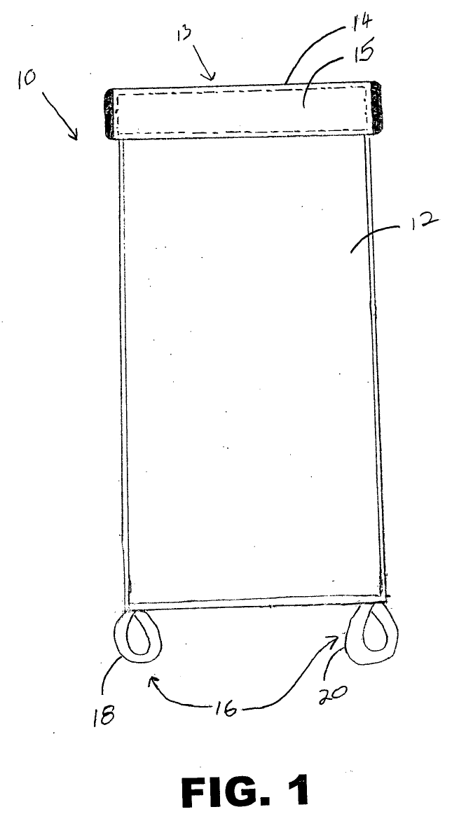

FIG. 1 is a top plan view of a preferred embodiment of a weighted placemat 10 according to the present invention. The placemat 10 comprises an eating surface 12, a first attachment assembly 13 selectively attached to the eating surface 12 for selectively attaching the placemat to a surface during use, and a second attachment assembly 16 for selectively attaching the placemat to a seat assembly during use. The term eating surface as it is used in this disclosure should be interpreted broadly and is simply the surface of the placemat 10 upon which food or items may be placed during use. The eating surface 12 is preferably made of, or covered by, a smooth, liquid-resistant material such as vinyl. Optionally, the eating surface 12 may be configured so as to be separately washable. In this particular embodiment, the first attachment assembly 13 comprises a weight 14. Alternative first attachment assemblies such as suction cups are contemplated and are considered to be within the scope of the invention.

In this particular embodiment, the second attachment assembly 16 comprises a first loop 18 and a second loop 20. The first loop 18 and second loop 20 may be fastened to legs of a seat (such as a highchair) thereby securing the weighted placemat to the seat. In an alternative embodiment, the second attachment assembly 16 comprises a second weight. The second weight may be placed over the leg brace of a seat thereby securing the weighted placemat to the seat. One skilled in the art can appreciate that any type of attachment mechanism is within the scope of the invention. For example, the second attachment assembly could comprise tethers that could simply be tied to the seat. The first attachment assembly may be selectively attached to a surface (such as a table) thereby securing the placemat 10 to the surface. As previously noted, the first attachment assembly of the embodiment comprises a weight 14. The weight 14 comprises a cavity capable of receiving a weighted member 15. The weighted member of this embodiment comprises a tubular weight; however, one skilled in the art can appreciate that alternative weights could be utilized without straying from the essence of the invention.

The present embodiment of the invention optionally comprises a carrying bag (not shown). The carrying bag preferably comprises compartments or other means for carrying the weighted placemat 10 and accessories such as a cup, a plate, and/or eating utensils. The carrying bag also comprises at least one strap for ease of transportation. One skilled in the art can appreciate that alternative means for transporting the weighted placemat could be substituted.

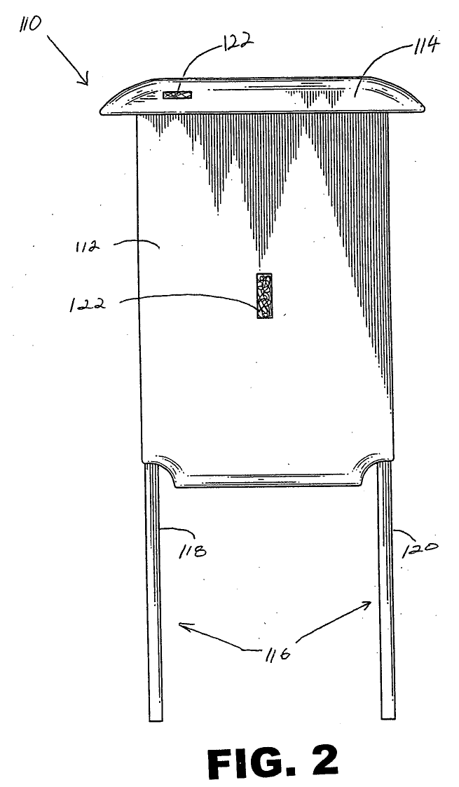

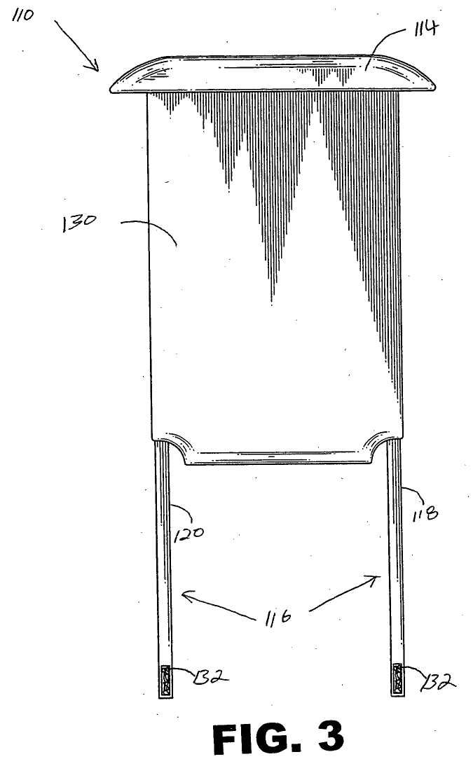

FIG. 2 is a top plan view of an alternative embodiment of a weighted placemat 110 according to the present invention. The placemat 110 comprises an eating surface 112, a weight 114 selectively attached to the eating surface 112, and an attachment assembly 116 for selectively attaching the placemat to a seat assembly during use. In this particular embodiment, the attachment assembly 116 comprises a first strap 118 and a second strap 120 having common hook and loop fasteners 132 (FIG. 3) attached thereto. The first strap 118 and second strap 120 may be fastened to legs of a seat (such as a highchair) thereby securing the weighted placemat to the seat.

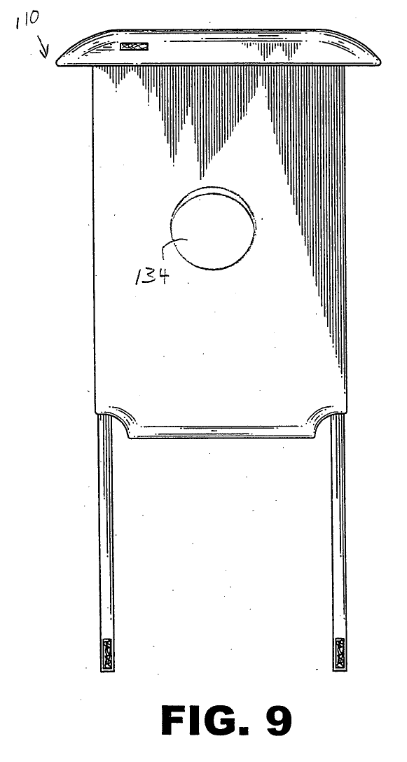

In light of the fact that children like to throw things, both the eating surface 112 and the weight 114 of the placemat 110 may optionally contain at least one accessory anchoring mechanism 122 for securing plates, cups, bottles or other accessories to the placemat 110. For example, accessories may be secured using hook and loop fasteners. Alternatively, the eating surface 112 or the weight 114 may comprise at least one cavity 134 (FIG. 9) for receiving an accessory. Such accessory anchoring mechanisms 122 assist in preventing a child from throwing accessories from the placemat.

FIG. 3 is a bottom plan view of an embodiment of weighted placemat 110 according to the present invention. The weighted placemat 110 may optionally comprise a second eating surface 130. The weight 114 is attached to the eating surfaces such that the weighted placemat is suitable for use with either eating surface facing upward. In a preferred embodiment, the weight 114 comprises a substantially tubular sand or liquid-filled body. Alternative shapes and types of weights are contemplated by the inventor and do not vary from the scope of the invention. The weight 114 may be permanently connected to the eating surfaces, or alternatively be detachably connected to the eating surfaces for ease of cleaning.

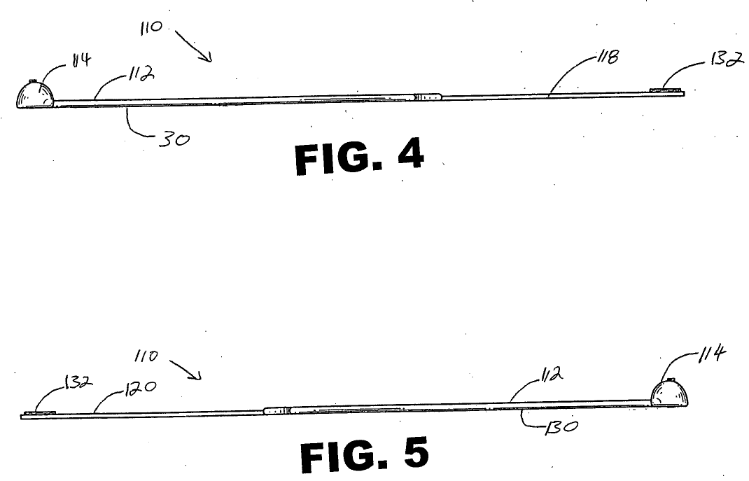

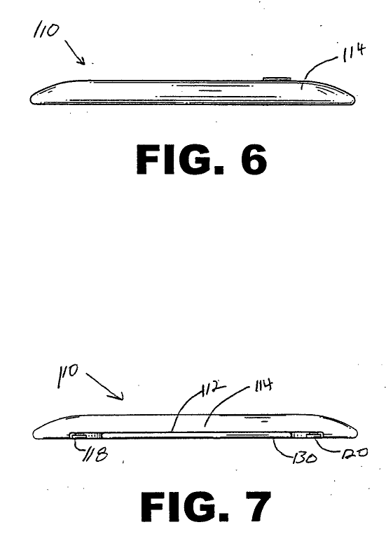

Referring now to FIGS. 4 and 5, the placemat 110 of the present invention is portable. Although depicted fully unrolled, the eating surface 112 and the attachment assembly 116 are pliable, and therefore may be rolled around the weight 114. When rolled up, the placemat 110 may be placed in the aforementioned carrying bag, tied up, or otherwise secured for transportation. FIGS. 6 and 7 are respective left and right elevational views of an embodiment of a weighted placemat 110 according to the present invention.

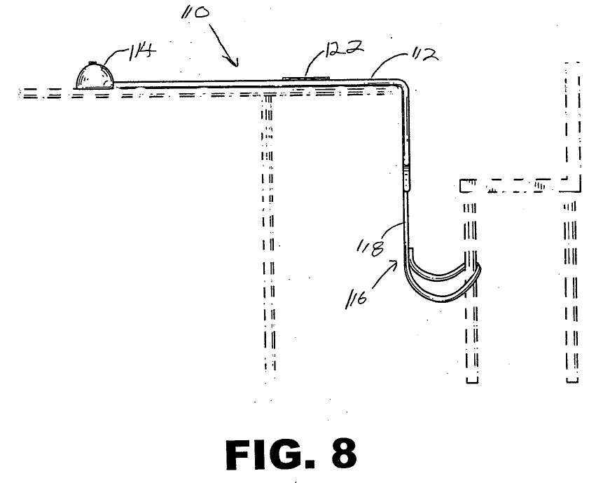

FIG. 8 is a front elevational view of an embodiment of a weighted placemat 110 according to the present invention. The weighted placemat 110 is depicted in its intended use with a table and a seat. The attachment mechanism 116 is attached to the legs of the seat. A substantial portion of the eating surface 112 is facing upward. Through gravity and friction, the weight 114 acts to keep the weighted placemat 110 from sliding off of the table.

The present invention is advantageous in that it is equally effective in a variety of situations. For example, the weighted placemat may be used with a kitchen counter and a tray-less highchair. The same weighted placemat may also be used with a table and a standard chair, such as one might expect to find at a restaurant. Once skilled in the art can also appreciate that the precise shape and configuration of the eating surface and the weight may easily be varied while not straying from the scope of the present invention.

An alternative embodiment of the placemat comprises a first end, a second end, a weight operably connected to the first end of the placemat, and an attachment assembly for selectively attaching the second end of the placemat to a seat during use. Another alternative embodiment of the placemat comprises a substantially rectangular member comprising a first end and a second end, a weight operably connected to the first end of the member, and an attachment assembly attached to the second end of the member. The substantially rectangular member may optionally further comprise first and second surfaces. Either surface may further comprise at least one accessory anchoring mechanism. The weight may be operably connected to the second end of the member such that either the first or second surface of the substantially rectangular member may face upward during use of the placemat. The substantially rectangular member may be made of plastic or any other appropriate pliable material.

Although the present invention has been described above in detail, the same is by way of illustration and example only and is not to be taken as a limitation on the present invention. For example, placemats of other configurations could be readily made by one having ordinary skill in the relevant art utilizing the teaching of the present invention. Accordingly, the scope and content of the present invention are to be defined only by the terms of the claims.

1. A placemat comprising:
an eating surface;
a first attachment assembly selectively attached to the eating surface for selectively attaching the placemat to a surface during use; and
a second attachment assembly for selectively attaching the placemat to a seat assembly during use.

2. The placemat of claim 1 wherein the first attachment assembly comprises a weight.

3. The placemat of claim 1 wherein the second attachment assembly comprises at least one strap.

4. The placemat of claim 1 wherein the eating surface further comprises at least one accessory anchoring mechanism.

5. The placemat of claim 2 wherein the weight further comprises at least one accessory anchoring mechanism.

6. The placemat of claim 4 wherein the accessory anchoring mechanism comprises a piece of hook and loop fastening material.

7. The placemat of claim 5 wherein the accessory anchoring mechanism comprises a piece of hook and loop fastening material.

8. The placemat of claim 1 wherein the eating surface is pliable.

9. The placemat of claim 1 further comprising a second eating surface.

10. The placemat of claim 1 wherein the second attachment assembly comprises a weight selectively attached to the eating surface.

11. The placemat of claim 2 wherein the weight comprises a cavity capable of receiving a weighted member.

12. A placemat comprising:
a first end;
a second end;
at least a first weight operably connected to the first end of the placemat; and
an attachment assembly for selectively attaching the second end of the placemat to a seat assembly during use.

13. The placemat of claim 12 wherein the attachment assembly comprises at least one strap.

14. The placemat of claim 12 further comprising at least one accessory anchoring mechanism.

15. The placemat of claim 14 wherein the accessory anchoring mechanism comprises a piece of hook and loop fastening material.

16. The placemat of claim 12 further comprising a second weight operably connected to the second end of the placemat.

17. The placemat of claim 12 wherein the first weight comprises a cavity capable of receiving a weighted member.

18. A placemat comprising:
a substantially rectangular member comprising a first end and a second end;
at least a first weight operably connected to the first end of the substantially rectangular member; and
an attachment assembly attached to the second end of the substantially rectangular member.

19. The placemat of claim 18 wherein the attachment assembly comprises at least one strap.

20. The placemat of claim 19 wherein the substantially rectangular member further comprises a first surface comprising at least one accessory anchoring mechanism, and a second surface.

21. The placemat of claim 18 wherein the first weight comprises at least one accessory anchoring mechanism.

22. The placemat of claim 20 wherein the first weight is operably attached to the first end of the substantially rectangular member such that either the first surface of the substantially rectangular member or the second surface of the substantially rectangular member may face upward during use of the placemat.

23. The placemat of claim 20 wherein the accessory anchoring mechanism comprises a piece of hook and loop fastening material.

24. The placemat of claim 18 wherein the substantially rectangular member is pliable.

25. The placemat of claim 18 further comprising a second weight operably connected to the second end of the substantially rectangular member.

26. The placemat of claim 18 wherein the first weight comprises a cavity capable of receiving a weighted member.
